(19) United States
(12) Patent Application Publication
(10) Pub. No.: US 2011/0218858 A1
(43) Pub. Date: Sep. 8, 2011

(54) Apparatus, Computer Program Product, and Method for Internet Advertising

(75) Inventor: Stephen T. Christensen, Draper, UT (US)

(73) Assignee: LOOP LINGO, INC., Draper, UT (US)

(21) Appl. No.: 12/718,766

(22) Filed: Mar. 5, 2010

(51) Int. Cl. G06Q 30/00; G06F 17/30

(52) U.S. Cl. 705/14.51; 707/769; 707/705; 707/E17.108

(57) ABSTRACT

An apparatus, computer program product, and method are disclosed for internet advertising. The apparatus includes an offer module, a publishing module, a posting module, and a linking module. The offer module visually presents one or more promotions to a first user in response to a first user entering a first purchasing context. The promotions contain offers. The publishing module, in response to an acceptance of the offer, creates at least one advertisement which comprises a link to a second purchasing context. The posting module posts the advertisement to a loop creation location. The linking module detects user input corresponding to the advertisement and displays the second purchasing context.

### BACKGROUND

1. Field of the Invention

This invention relates to internet advertising and more particularly relates to creation and monitoring of advertisements.

2. Description of the Related Art

Online sales have increased dramatically over the last decade. Research indicates the general public is more comfortable purchasing products online and is becoming more inclined to make their purchases online. As a result of this increase in online sales, internet advertising has become an important industry which reaches people that might not have been reached through traditional print advertising.

Internet advertising is considered to have a broader scope than typical print advertising because it reaches people through multiple gateways, such as the e-mail, wireless media, internet television, and personal computers. Internet advertising allows retailer with brick-and-mortar businesses, as well as purely internet based businesses, to reach the vast number of people that access the internet. Internet advertising is also relatively inexpensive when compared to other types of advertising. Internet advertising also tends to have a lower ratio of cost per customers reached. This allows smaller companies to reach a wide audience for a small fraction of traditional advertising budgets. The nature of internet commerce allows customers to research and purchase products and services at their own convenience.

Internet advertising has given rise to a number of sub-industries such as lead-based websites, affiliate marketing, local internet marketing, search engine marketing, and web analytics. Internet marketers can measure statistics concerning the effectiveness of their marketing strategies through known web analytic methods. While internet advertising has progressed due to its effectiveness and broad application, there are several disadvantages to known internet advertising.

One disadvantage of known internet advertising is that it does not present incentives to internet shoppers for posting current purchase details to locations that are viewed by the user and his or her social acquaintances. Also, known internet advertising does not provide online retailers with the ability to simultaneously post advertisements to multiple internet locations which are unique to a user that has shown interest in the online retailer's products or services. Additionally, known internet advertising does not provide integration of a website and advertising at separate locations that are viewed by a known purchaser from the website and his or her acquaintances. Additionally, known internet advertising does not provide monitoring of advertisements originating from a buyer and rewards to the buyer for subsequent user input and purchases that result from the buyer's advertisements.

### SUMMARY

From the foregoing discussion, it should be apparent that a need exists for an apparatus, computer program product, and method that place customized advertisements at different locations within the online customer engagement cycle. Beneficially, such an apparatus, computer program product, and method would automatically place advertisements at user specified locations.

The present invention has been developed in response to the present state of the art, and in particular, in response to the problems and needs in the art that have not yet been fully solved by currently available online advertising methods. Accordingly, the present invention has been developed to provide an apparatus, computer program product, and method for internet advertising that overcome many or all of the above-discussed shortcomings in the art.

The apparatus to advertise on the internet is provided with a plurality of modules configured to functionally execute the necessary steps of visually presenting one or more promotions to a first user in response to the first user entering a first purchasing context associated with a first product; creating at least one advertisement corresponding to the first product; posting the at least one advertisement to one or more loop creation locations; detecting user input corresponding to one of the at least one advertisements; and displaying a second purchasing context. These modules in the described embodiments include an offer module, a publishing module, a posting module, a linking module, a user information module, a data module, a subsequent offer module, a subsequent publishing module, a subsequent posting module, a subsequent linking module, a second data module, an award module, an exchange module, a scoring module, a bidding module, a rating module, a third data module, a client information module, a search module, and a dynamic display module.

In one embodiment, the offer module visually presents one or more promotions to a first user in response to the first user entering a first purchasing context associated with a first product. In one embodiment, the one or more promotions comprise an offer that corresponds to the first product.

In one embodiment, the publishing module, in response to an acceptance of the offer by the first user, creates at least one advertisement corresponding to the first product. In one embodiment, the at least one advertisement comprises a link to a second purchasing context.

In a further embodiment, the posting module posts the at least one advertisement created by the publishing module to one or more loop creation locations selected by the first user. In another embodiment, the linking module detects user input corresponding to one of the at least one advertisements and, in response to detecting the user input corresponding to the one of the at least one advertisements, displays the second purchasing context.

In one embodiment, the first purchasing context and the second purchasing context are the same purchasing context. In another embodiment, the one or more promotions comprise a user selectable list of one or more loop creation locations. In one embodiment, a loop creation location comprises at least one of a portion of a webpage and a webpage.

In another embodiment, the publishing module further comprises a user information module that, in response to an acceptance of the offer by the first user, receives user input corresponding to a user selectable list of one or more loop creation locations. The user information module also stores the user input and associates the user input with the first user. In one embodiment, a loop creation location comprises at least one of a portion of a webpage and a webpage.

In a further embodiment, the offer module searches a product database and locates an offer that corresponds to the first product by locating an offer that is associated with a category of the first product. In another embodiment, the apparatus further comprises a data module that, in response to an acceptance of the offer by the first user, receives a user identifier, an advertisement identifier, a product identifier, a loop creation location identifier, and a merchant identifier. The data module also associates the user identifier, the advertisement identifier, the product identifier, the loop creation location identifier, and the merchant identifier with the advertisement created by the publishing module. Additionally, the data module receives, in response to detecting a user input corresponding to the advertisement, the user identifier, the advertisement identifier, the product identifier, the loop creation location identifier, and the merchant identifier associated with the advertisement.

In a further embodiment, the apparatus further comprises a subsequent offer module, a subsequent publishing module, a subsequent posting module, and a subsequent linking module. In one embodiment, the subsequent offer module, in response to detecting user input corresponding to an advertisement, visually presents one or more promotions to a subsequent user. The one or more promotions correspond to a product associated with the advertisement and comprise an offer that corresponds to the product.

In one embodiment, the subsequent publishing module, in response to an acceptance of the offer by the subsequent user, creates at least one advertisement corresponding to the product. The at least one advertisement comprises a link to a third purchasing context.

In one embodiment, the subsequent posting module posts the at least one advertisement created by the subsequent publishing module to one or more loop creation locations selected by the subsequent user. In another embodiment, the subsequent linking module detects the user input corresponding to the advertisement and, in response to detecting user input corresponding to the advertisement, displays the third purchasing context.

In a further embodiment, the apparatus further comprises a second data module that, in response to an acceptance of the subsequent offer, receives a user identifier, an advertisement identifier, a product identifier, a loop creation location identifier, and a merchant identifier. The second data module associates the user identifier, the advertisement identifier, the product identifier, the loop creation location identifier, and the merchant identifier with the subsequent advertisement. The second data module also receives, in response to detecting a user input corresponding to the subsequent advertisement, the user identifier, the advertisement identifier, the product identifier, the loop creation location identifier, and the merchant identifier associated with the subsequent advertisement.

In one embodiment, the apparatus further comprises an award module that associates a user identifier with an award set and records an award associated with the user identifier in response to completion of a task within the award set. The award set comprises tasks that are associated with awards. In another embodiment, the apparatus further comprises an exchange module that receives an award from a giving user and deposits the award with a receiving user.

In another embodiment, the linking module further comprises a scoring module that assigns a score to an advertisement identifier associated with an advertisement according to a number of detected user inputs corresponding to the advertisement. In a further embodiment, the scoring module further comprises a bidding module that receives a score assigned to an advertisement identifier, associates a bidding price with the score, and associates the bidding price with the advertisement identifier.

In one embodiment, the scoring module further comprises a rating module that, in response to detecting a user input corresponding to the advertisement, receives user input in the form of a user rating associated with the first user and an advertisement rating associated with the advertisement.

In one embodiment, the publishing module creates the at least one advertisement corresponding to the first product automatically by combining product data retrieved from a product database according to a predetermined algorithm. In an additional embodiment, the publishing module creates the at least one advertisement corresponding to the first product by retrieving a pre-designed advertisement from a product database.

In one embodiment, the loop creation location comprises at least one of a personal information page on a social networking website, a text based post displayed on one or more webpages, a text based post on one or more cell phones, a personal webpage, and an internet search page. In another embodiment, the offer module visually presents the one or more promotions to the first user by integrating the one or more promotions into the purchasing context for the first product. In an additional embodiment, the offer module visually presents the one or more promotions to the first user by presenting a window comprising the one or more promotions.

In one embodiment, the purchasing context comprises a webpage that makes a product offer to the first user, the product offer corresponding to the first product. In another embodiment, the first purchasing context comprises at least one of an e-commerce webpage, an online store website, a lead generation website, a subscription website, a services subscription website, a movie review website, a book review website, a political campaign website, and a charity donation website.

In another embodiment, the first product comprises at least one of a product for sale online, a service for sale online, a subscription, a promotion, a news piece, a solicitation for a donation, a solicitation to fill out a form, a solicitation to enter personal information, and a solicitation to give feedback concerning one or more of a movie, a book, music, software, and a product. In a further embodiment, the advertisement further comprises a chat window that receives user input from a subsequent user and displays the user input to the first user.

In one embodiment, the apparatus further comprises a third data module that detects user input corresponding to one of the at least one advertisements and receives a product purchase indicator associated with the purchase of the first product. The third data module records a product purchase indicator associated with the advertisement.

In another embodiment, the apparatus further comprises a client information module that, in response to detecting user input corresponding to the advertisement, visually presents a demographic data menu to a second user and receives and associates the demographic data from the user input with a user identifier, an advertisement identifier, and a product identifier. In a further embodiment, the client information module further comprises a search module that allows a user to search for products associated with demographic data recorded by the client information module. In yet another embodiment, the client information module further comprises a dynamic display module that receives demographic data associated with a product from the client information module, locates other loop creation locations that correspond to the demographic data, and then posts at least one advertisement corresponding to the product to the located loop creation locations.

In one embodiment, the first product comprises an audio file and wherein the advertisement corresponding to the first product further comprises a link to a portion of the audio file.

A computer program product comprising a computer readable medium having computer usable program code executable to perform operations for internet advertising is also presented. The operations of the computer program product include the steps necessary to carry out the function presented above with respect to the operation of the described apparatus. In one embodiment, the computer program product includes the operations of visually presenting one or more promotions to a first user in response to the first user entering a first purchasing context for a first product; creating, in response to an acceptance of the offer by the first user, at least one advertisement corresponding to the first product; posting the at least one advertisement created by the publishing module to one or more loop creation locations selected by the first user; and detecting user input corresponding to one of the at least one advertisements and, in response to detecting the user input corresponding to the one of the at least one advertisements, displaying the second purchasing context.

In one embodiment, the one or more promotions comprise an offer that corresponds to the first product. In another embodiment, the at least one advertisement comprises a link to a second purchasing context. In a further embodiment, the first purchasing context and the second purchasing context are the same purchasing context.

A method of the present invention is also presented for internet advertising. The method in the disclosed embodiments substantially includes the steps necessary to carry out the functions presented above with respect to the operation of the described apparatus and computer program product. In one embodiment, the method includes visually presenting one or more promotions to a first user in response to the first user entering a first purchasing context for a first product. In one embodiment, the one or more promotions comprise an offer that corresponds to the first product. The method also may include creating, in response to an acceptance of the offer by the first user, at least one advertisement corresponding to the first product. In one embodiment, the at least one advertisement comprises a link to a second purchasing context.

In a further embodiment, the method includes posting the at least one advertisement created by the publishing module to one or more loop creation locations selected by the first user. In another embodiment, the method includes detecting the user input corresponding to one of the at least one advertisements and, in response to detecting the user input corresponding to the one of the at least one advertisements, displays the second purchasing context. In another embodiment, visually presenting one or more promotions comprising an offer that corresponds to the first product comprises searching a product database and locating an offer that corresponds to the first product by locating an offer that is associated with a category of the first product.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an apparatus for internet advertising in accordance with the present invention;

FIG. 2 is a schematic block diagram illustrating another embodiment of an apparatus for internet advertising in accordance with the present invention;

FIG. 3 is a schematic block diagram illustrating one embodiment of a first purchasing context in accordance with the present invention;

FIG. 4 is a schematic block diagram illustrating an additional embodiment of an apparatus for internet advertising in accordance with the present invention;

FIG. 5 is a schematic block diagram illustrating one embodiment of an apparatus for internet advertising in accordance with the present invention;

FIG. 6 is a schematic block diagram illustrating another embodiment of an apparatus for internet advertising in accordance with the present invention;

FIG. 7 is a schematic block diagram illustrating an additional embodiment of an apparatus for internet advertising in accordance with the present invention;

FIG. 8 is a schematic block diagram illustrating one embodiment of an apparatus for internet advertising in accordance with the present invention;

FIG. 9 is a schematic block diagram illustrating another embodiment of an apparatus for internet advertising in accordance with the present invention;

FIG. 10 is a schematic block diagram illustrating an additional embodiment of an apparatus for internet advertising in accordance with the present invention;

FIG. 11 is a schematic block diagram illustrating one embodiment of an apparatus for internet advertising in accordance with the present invention;

FIG. 12 is a schematic block diagram illustrating another embodiment of an apparatus for internet advertising in accordance with the present invention;

FIG. 13 is a schematic block diagram illustrating an additional embodiment of an apparatus for internet advertising in accordance with the present invention;

FIG. 14 is a schematic block diagram illustrating one embodiment of an apparatus for internet advertising in accordance with the present invention;

FIG. 15 is a schematic block diagram illustrating one embodiment of an advertisement in accordance with the present invention;

FIG. 16 is a schematic block diagram illustrating one embodiment of an apparatus for internet advertising in accordance with the present invention;

FIG. 17 is a schematic block diagram illustrating another embodiment of an apparatus for internet advertising in accordance with the present invention; and

FIG. 18 is a schematic flow chart diagram illustrating one embodiment of a method for internet advertising in accordance with the present invention.

### DETAILED DESCRIPTION

As will be appreciated by one skilled in the art, aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

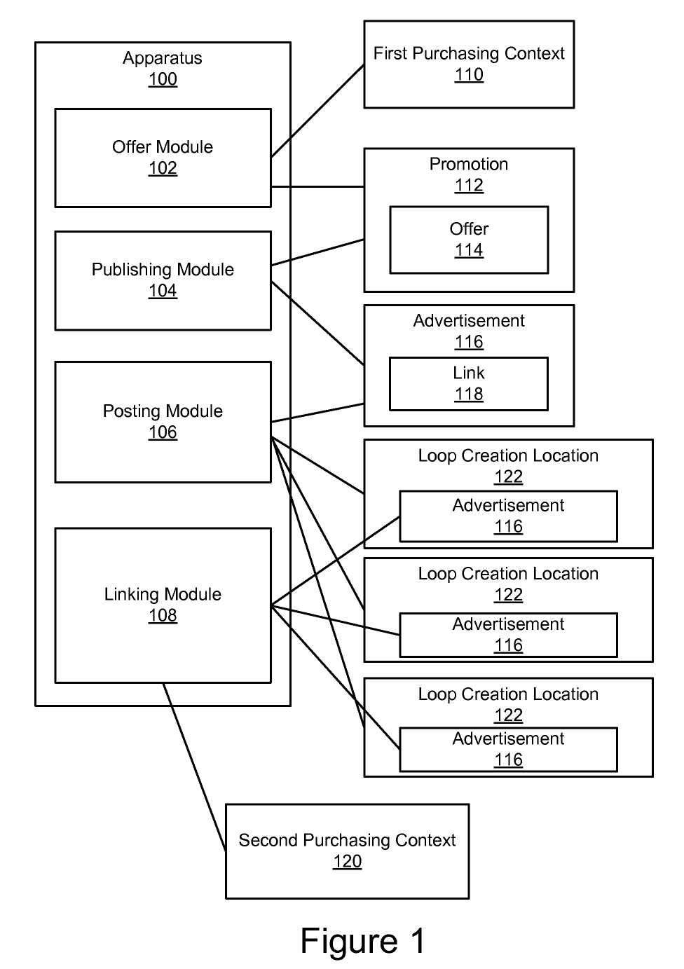

FIG. 1 depicts one embodiment of an apparatus 100 for internet advertising. The illustrated apparatus 100 includes an offer module 102, a publishing module 104, a posting module 106, and a linking module 108. In general, the offer module 102 visually presents one or more promotions 112 to a first user in response to the first user entering a first purchasing context 110. In response to an acceptance of the offer 114 by the first user, the publishing module 104 creates at least one advertisement 116 corresponding to the first product. The posting module 106 posts the at least one advertisement 116 to one or more loop creation locations 122 selected by the first user. Finally, the linking module 108 detects user input corresponding to one of the at least one advertisements 116 and displays a second purchasing context 120.

In one embodiment, the offer module 102, the publishing module 104, the posting module 106, and the linking module 108 are communicatively coupled over a network. In one embodiment, the apparatus 100 also includes a web server. A web server, in a further embodiment, may support HyperText Transfer Protocol (HTTP), handle document requests, returning information to a requestor, and/or provide other services. The web server may communicate by exposing web services which communicate XML, or the like. In another embodiment, the apparatus 100 also includes a server application that functions as a server, such as a program that listens to a specific port for incoming requests.

In one embodiment, the offer module 102 is communicatively coupled to a first purchasing context 110 for a first product and receives notification that a first user has entered the first purchasing context 110. In response to the first user entering the first purchasing context 110, the offer module 102 visually presents one or more promotions 112 to the first user. In one embodiment, the one or more promotions 112 include an offer 114 that corresponds to the first product. In one embodiment, the offer 114 includes a text description with a hyperlink. In another embodiment, the offer 114 has a clickable image or animation with a hyperlink. In another embodiment, a style of the offer 114 matches a style of the first purchasing context 110. In yet another embodiment, the offer 114 is styled to match a style common to many purchasing contexts.

In one embodiment, an online retailing website server contains the offer module 102 and the purchasing context is a webpage. In one embodiment, the first purchasing context 110 is a purchasing webpage used to purchase a product. The offer module 102 receives notification from the online retailing website server that a user has clicked a hyperlink associated with entering a purchasing webpage. The hyperlink, in one embodiment, may contain data describing the product that will be purchased in the purchasing webpage. As the purchasing website server generates the purchasing context, in a further embodiment, the purchasing website server merges the promotion 112 into the purchasing context webpage. In another embodiment, the purchasing context webpage is generated normally and the user's web browser is instructed to make an additional request to the purchasing context to retrieve the promotion 112.

The purchasing contexts 110, 120 can take many forms. In one embodiment, a purchasing context 110, 120 has a webpage associated with the purchase of a product. In another embodiment, the purchasing context 110, 120 includes a webpage that makes a product offer having to do with a product. In another embodiment, the purchasing context 110, 120 includes one or more of an e-commerce webpage, an online store website, a lead generation website, a subscription website, a services subscription website, a move review website, a book review website, a political campaign website, and a charity donation website.

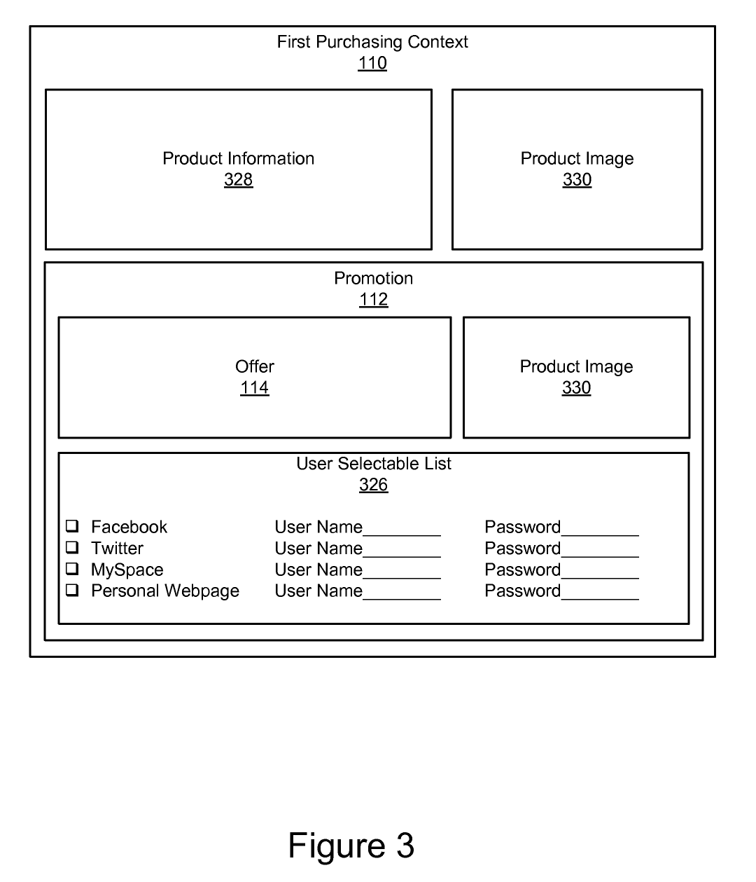

The offer 114 that the offer module 102 presents and that is contained within the promotion 112 corresponds to the first product. In one embodiment, the offer 114 displays a discount on the purchase price of the first product if the user agrees to post an advertisement 116 to one of the user's loop creation locations 122. One example of the promotion 112 is provided and described in more detail with reference to FIG. 3.

In one embodiment, the publishing module 104 creates at least one advertisement 116 in response to the first user accepting the offer 114. In one embodiment, the advertisement 116 corresponds to the first product. In an additional embodiment, the advertisement 116 contains an advertisement offer that is similar to the offer 114 contained within the promotion 112. In another embodiment, the publishing module 104 receives user input in the form of text and places the text within the advertisement 116.

The publishing module 104 creates the at least one advertisement 116 in response to the first user accepting the offer 114. The user can accept an offer 114 by clicking a button or image on the promotion 112, by selecting a user-selectable option, by clicking a text link, or any similar means that conveys the acceptance of the offer 114.

The at least one advertisement 116, in one embodiment, corresponds to the first product and comprises a link 118 to a second purchasing context 120. In one embodiment, the link 118 is a hypertext link 118 which, when selected, instructs a web browser to retrieve the second purchasing context 120 from a web server and to display the second purchasing context 120 to a user. In another embodiment, the link 118 is a hypertext link 118 to a webpage on a separate server which collects data and then instructs a web server to display the second purchasing context 120. The link 118 may be displayed as a graphic, text, a combination of text and graphics, animation, or any other type of internet link.

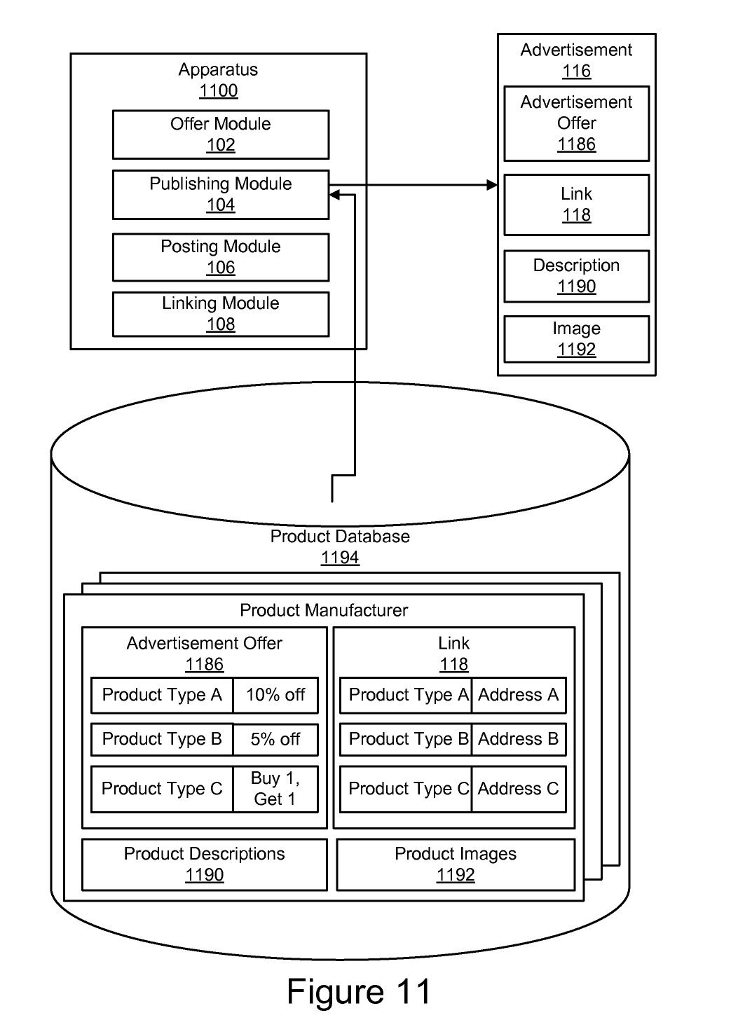

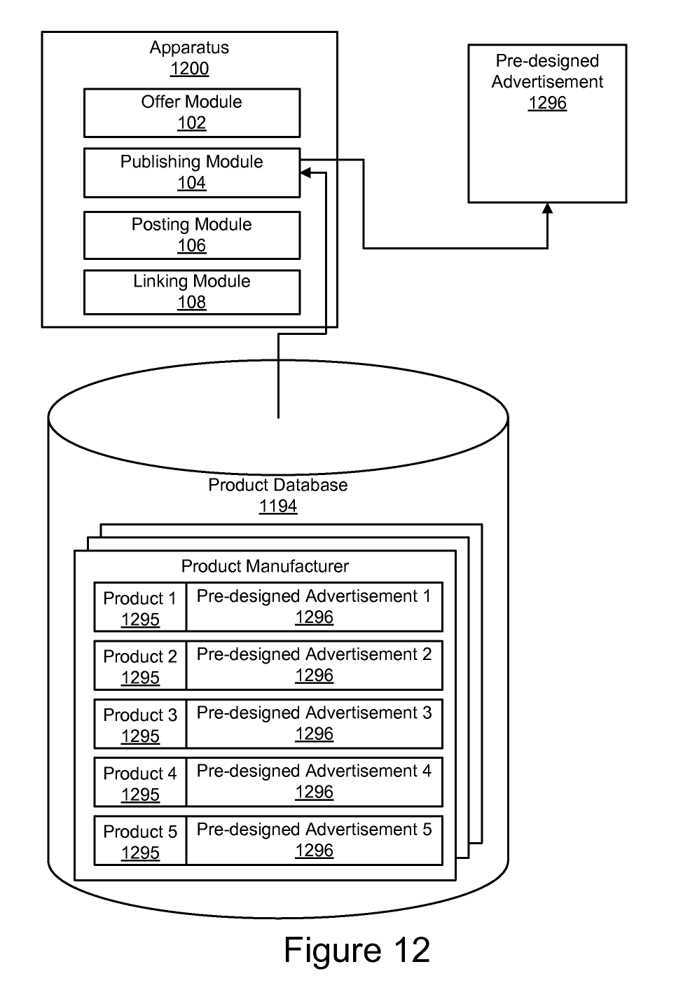

In one embodiment, the publishing module 104 creates the at least one advertisement 116 by inserting information specific to the advertisement 116 into a pre-defined advertisement template. The information that is inserted into the pre-defined advertisement template, in various embodiments, may include an image of a purchased product, price information, a textual description of the product, and/or other information relating to the product. In another embodiment, the publishing module 104 creates the at least one advertisement 116 by inserting user input and user comments into a pre-defined advertisement template. Additional embodiments of the publishing module 104 creating the advertisement 116 are provided and described in more detail with reference to FIGS. 11 and 12.

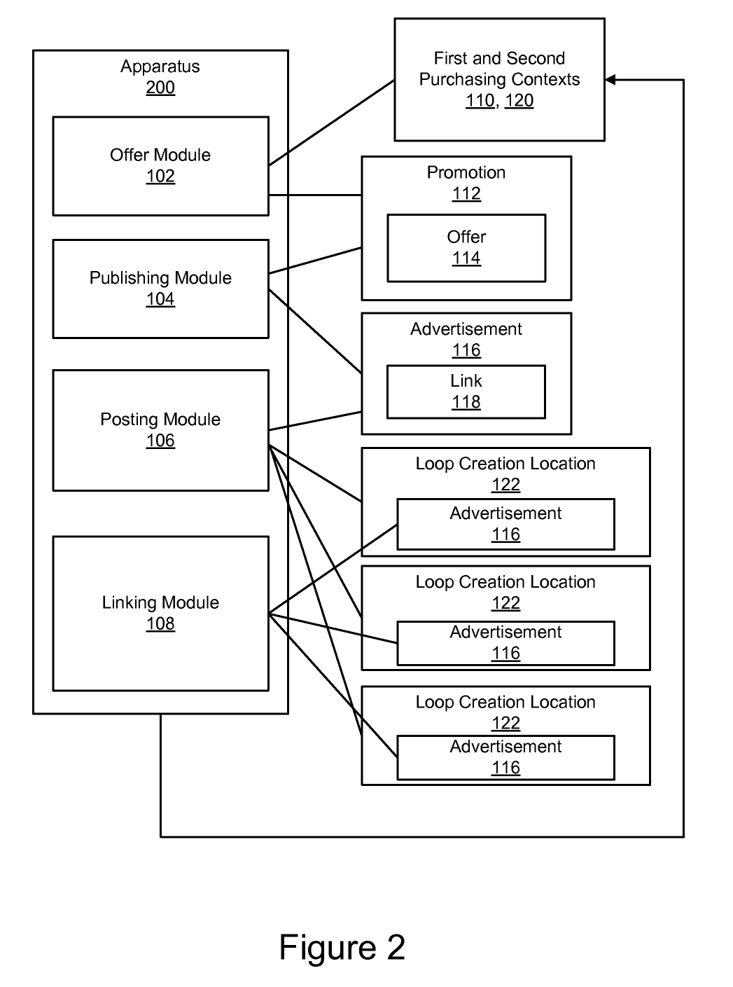

In one embodiment, the second purchasing context 120 corresponds to the first product. In a further embodiment, the second purchasing context 120 is the same purchasing context as the first purchasing context 110, as shown in FIG. 2.

In one embodiment, the posting module 106 posts the at least one advertisement 116 created by the publishing module 104 to one or more loop creation locations 122. The loop creation locations 122, in one embodiment, are locations at which a user can access information. A loop creation location 122, in various embodiments, may be a personal information webpage on a social networking website, a text-based post on one or more cell phones, a personal webpage, an internet search page, an instant messenger page, or another location where a user can access information. In one embodiment, a loop creation location 122 includes one or more webpages. In another embodiment, the loop creation location 122 is an email server that can receive messages and then forward messages to other users. In another embodiment, the loop creation location 122 is another type of service that can receive messages to be sent to other users. In one embodiment, a loop creation location 122 is a content service provider that displays content authorized by individual users, such as a social networking page or a blog.

Loop creation locations 122, in various embodiments, may be accessed through many different client devices such as desktop computers, laptop computers, PDAs, workstations, mobile phones, internet enabled TVs, and the like. Specific example embodiments of loop creation locations 122 include a personal Facebook page, a personal MySpace page, an email address, a message board, a discussion forum, a Twitter account, and the like.

In one embodiment, the linking module 108 detects user input corresponding to the advertisement 116. In one embodiment, user input at the advertisement 116 includes a click by a user. In response to detecting user input corresponding to the advertisement 116, in one embodiment, the linking module 108 displays the second purchasing context 120. In one embodiment, the advertisement 116 contains a link 118 to the linking module 108. When a user clicks the link 118, the linking module 108, in one embodiment, receives a request sent by the user's web browser. In a further embodiment, the request includes an advertisement identifier that the linking module 108 assigns to the particular click of the link 118. In one embodiment, the linking module 108 records a click associated with an advertisement identifier and records the click for analytical purposes. In one embodiment, after the linking module 108 has recorded a click associated with an advertisement 116, the linking module 108 redirects the user's web browser to the second purchasing context 120.

In various embodiments, the first product may be one or more of a product for sale online, a service for sale online, a subscription, a promotion, a news piece, a solicitation for a donation, a solicitation to fill out a form, a solicitation to enter personal information, and/or a solicitation to give feedback concerning a movie, book, music, software, other entertainment, or product. The first product is not limited to a product or service that is for sale.

In another embodiment, the first product includes an audio file and the advertisement 116 corresponding to the first product also includes an audio file. In one embodiment, the advertisement 116 associated with the first product includes an audio clip from the first product that plays several seconds of an original audio file. In another embodiment, the advertisement is a low fidelity audio file that is a low fidelity version of the original audio file. In one embodiment, the audio file is embedded in the advertisement 116, for example the advertisement may be embedded in an Adobe Flash object or the like. In another embodiment, the audio file is served by a remote web server that contains the audio file.

FIG. 2 depicts one embodiment of an apparatus 200 for internet advertising that may be substantially similar to the apparatus 100 for internet advertising of FIG. 1. As described above, in one embodiment, the offer 114 module 102 presents one or more promotions 112 to a first user in response to the first user entering the first purchasing context 110 for a first product. In response to the first user accepting the offer 114, the publishing module 104 creates at least one advertisement 116 corresponding to the first product. The posting module 106 posts the at least one advertisement 116 created by the publishing module 104 to one or more loop creation locations 122 selected by the first user. The linking module 108, upon detecting user input corresponding to the advertisement 116, displays the second purchasing context 120.

In one embodiment, the first purchasing context 110 and the second purchasing context 120 correspond to the first product. In another embodiment, the first purchasing context 110 and the second purchasing context 120 are the same purchasing context.

FIG. 3 depicts one embodiment of a first purchasing context 110 that may be substantially similar to the first purchasing context 110 of FIG. 1. As described above, in one embodiment, the offer module 102 visually presents one or more promotions 112 to a first user in response to the first user entering the first purchasing context 110 that is associated with the first product. The one or more promotions 112 include an offer 114 that also corresponds to the first product.

In one embodiment, the one or more promotions 112 include an offer 114, a product image 330, and a user selectable list 326 of one or more loop creation locations 122. In one embodiment, the first purchasing context 110 includes product information 328, a product image 330, and the promotion 112. In one embodiment, a loop creation location 122 includes one of a portion of a webpage and a webpage. In one embodiment, the posting module 106 posts the at least one advertisement 116 to the one or more loop creation locations 122 selected by the first user.

In one embodiment, user selections from the user selectable list 326 of one or more loop creation locations 122 are stored in a data storage device within the apparatus 100 or in communication with the apparatus 100. In one embodiment, when any user that has selected one or more loop creation locations 122 from the user selectable list 326 returns to the first purchasing context 110 or any other purchasing context, the user is not required to re-select loop creation locations 122 but is given the option of immediately posting advertisements 116 to previously selected loop creation locations 122.

In one embodiment, the posting module 106 includes a database wherein the posting module 106 stores a user's selections of loop creation locations 122. In one embodiment, the posting module 106 stores user preferences input by a user to a window presented by the posting module 106 in the database. In one embodiment, the posting module 106 stores loop creation locations 122 selected by a user in the database. In one embodiment, the posting module 106 stores information necessary to allow the posting module 106 to access a loop creation location 122 on the database. In one example embodiment, the posting module 106 stores a user's unique identifier, such as a username, for each social network website in the database. In another example embodiment, the posting module 106 also stores a user's permission token, such as a password, that grants the posting module 106 permission to access a social network webpage on the user's behalf in the database. In another example embodiment, the posting module 106 also stores other data, such as data that indicates where to post advertisements 116 to the social network webpage and user preferences concerning display preferences for the advertisements 116 for each social network site, to the database.

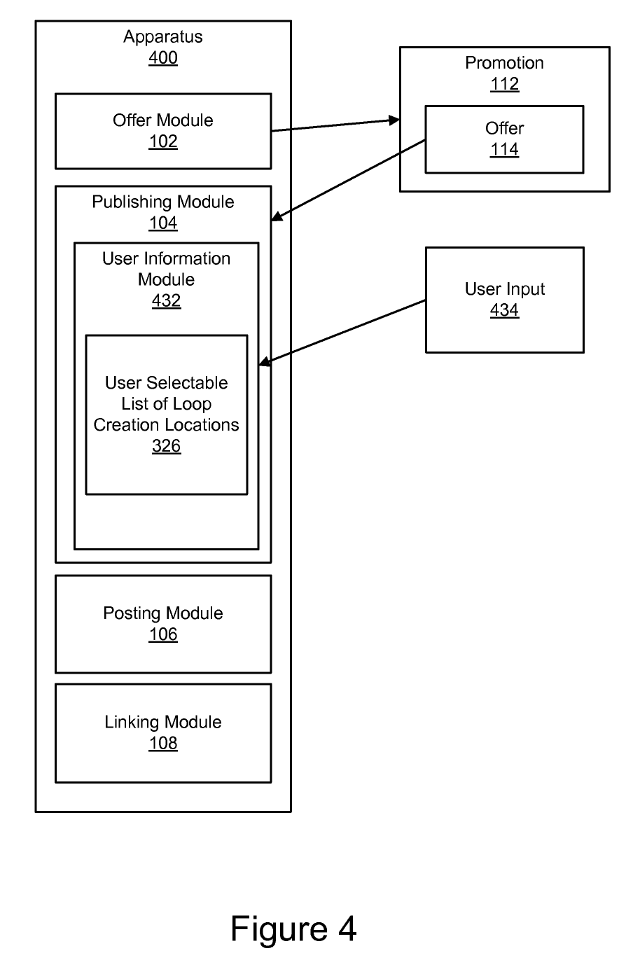

FIG. 4 depicts one embodiment of an apparatus 400 for internet advertising that may be substantially similar to the apparatus 100 for internet advertising of FIG. 1. As described above, in one embodiment, the offer module 102 presents one or more promotions 112 to a first user in response to the first user entering a first purchasing context 110. In one embodiment, the one or more promotions 112 comprise an offer 114 that corresponds to the first product. In another embodiment, in response to an acceptance of the offer 114 by the first user, the publishing module 104 creates at least one advertisement 116 corresponding to the first product.

In one embodiment, the publishing module 104 further includes a user information module 432 that, in response to the first user accepting the offer 114, receives user input 434 to a user selectable list 326 of one or more loop creation locations 122, stores the user input 434, and associates the user input 434 with the first user. In one embodiment, in response to the first user accepting the offer 114, the publishing module 104 visually presents a window including a user selectable list 326 of one or more loop creation locations 122. In one embodiment, the window also includes user input fields to receive a user login, a user password, and an advertisement caption. In one embodiment, the publishing module 104 associates the user login and user password with selected loop creation locations 122. In one embodiment, the window includes user input fields for the user login and user password. In one embodiment, in response to the publishing module 104 verifying the user login and user password, the posting module 106 automatically posts the advertisement 116 to previously selected loop creation locations 122.

In one embodiment, in response to the first user accepting the offer 114, the publishing module 104 receives a link click indicator. Upon receipt of the link click indicator, in one embodiment, the publishing module 104 instructs a user's web browser to open a new window which prompts the user to enter the user's login information corresponding to a loop creation location 122. In one embodiment, the loop creation location 122 is a social network webpage. In another embodiment, the publishing module 104 instructs the social network website itself to open a new window that prompts a user to enter the user's login information for social network website. In one example embodiment, Facebook Connect opens a new window that prompts the user to enter the user's login information. In yet another embodiment, the user information module 432 receives the user's login information and then instructs the publishing module 104 to connect to the user's social network website on the user's behalf. In another embodiment, the user information module 432 verifies that the user input 434 is valid and then instructs the posting module 106 to create the advertisement 116.

In one embodiment, in response the publishing module 104 creating the advertisement 116, the publishing module 104 sends a message directly to the first purchasing context 110 to indicate the successful creation of the advertisement 116. In another embodiment, in response to the publishing module 104 creating the advertisement 116, the publishing module 104 directs a user's web browser to reload the first purchasing context 110, and sends an indicator, such as a token, that the advertisement 116 was successfully created to a server associated with the first purchasing context 110. In yet another embodiment, the publishing module 104 receives a message from the web server of the first purchasing context 110 inquiring if the advertisement 116 has been created and responds to the web server of the first purchasing context 110.

In another embodiment, the publishing module 104 sends a verification to the first purchasing context 110 verifying that the advertisement 116 has been created. In one example, upon receiving the verification, the first purchasing context 110 updates its display to show that the offer 114 has been accepted. In one example, in response to the publishing module 104 creating the advertisement 116, a server associated with the purchasing context 110 updates the purchasing context to show a reduced purchase price associated with the first product.

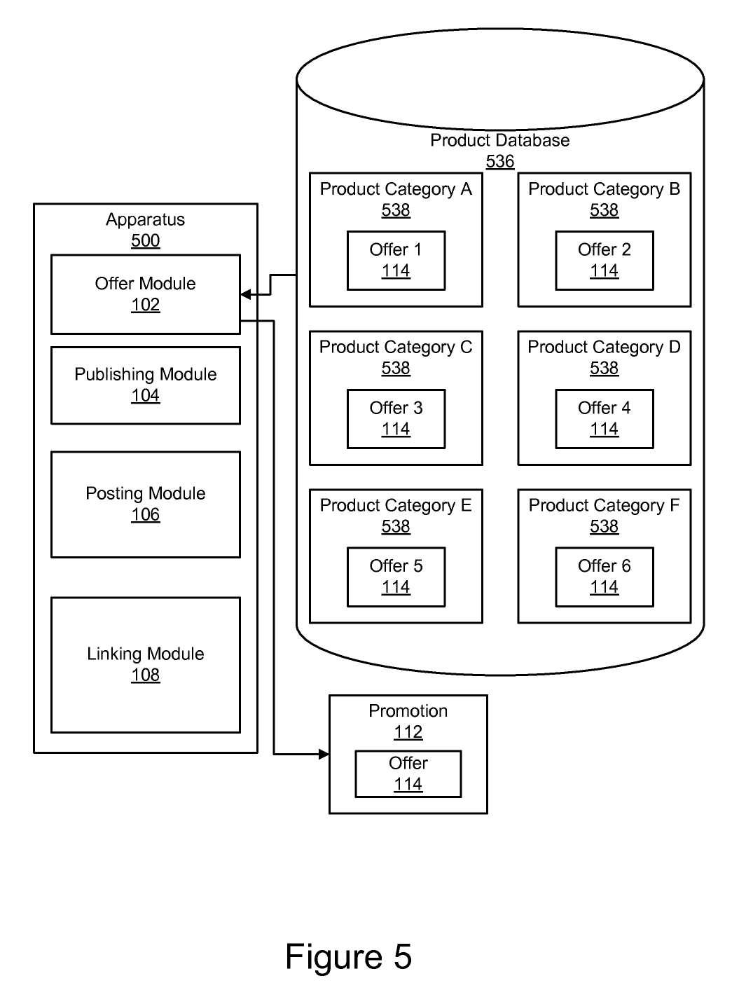

FIG. 5 depicts one embodiment of an apparatus 500 for internet advertising that may be substantially similar to the apparatus 100 for internet advertising of FIG. 1. As described above, in one embodiment, the offer module 102 visually presents one or more promotions 112 to a first user in response to the first user entering a first purchasing context 110 for a first product. In one embodiment, the one or more promotions 112 include an offer 114 that also corresponds to the first product.

In one embodiment, the offer module 102 searches a product database 536 and locates an offer 114 that corresponds to the first product by locating an offer 114 that is associated with a category 538 of the first product. In another embodiment, the offer module 102 searches for an offer 114 that is specifically associated with the first product. In another embodiment, the offer module 102 searches for an offer 114 that is associated with the generate category 538 to which the first product belongs. In yet another embodiment, the offer module 102 searches for an offer 114 based on criteria not directly related to the first product. In one example embodiment, the offer module 102 searches for offers 114 related to the date on which the first purchasing context 110 was entered. In another example embodiment, the offer module 102 searches for a seasonal offer 114 associated with the date on which the first purchasing context 110 was entered. In another embodiment, the offer module 102 searches for offers 114 corresponding to a purchase history of the user. In yet another embodiment, the offer module 102 randomly searches for an offer 114 to simulate a random drawing. In one embodiment, business logic associated with the first product determines the rules associated with the search performed by the offer module 102. In various embodiments, the business logic may be represented by one of programming language contained within the offer module 102 and a direct lookup in a database.

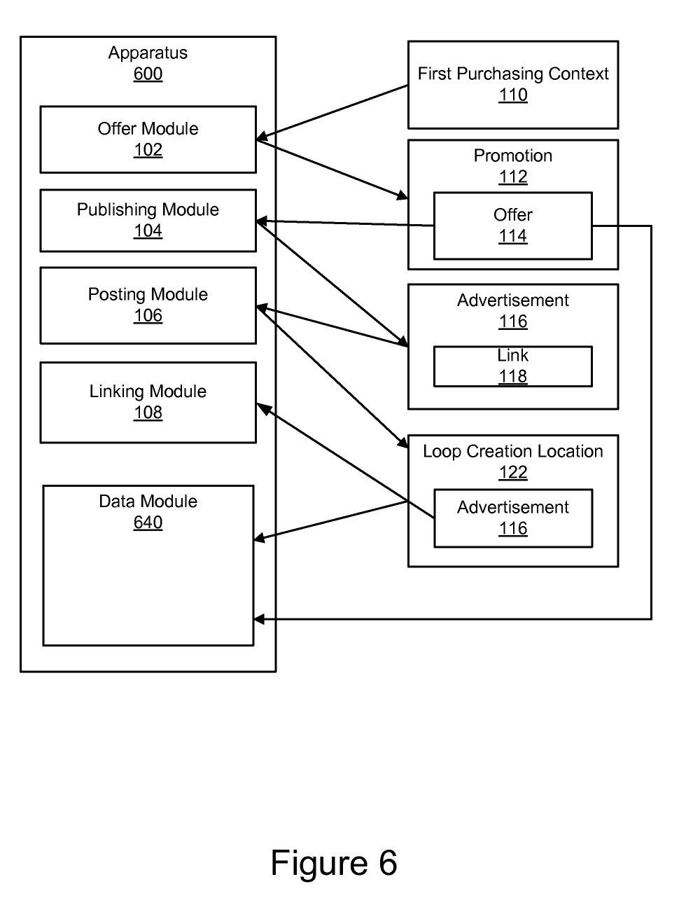

FIG. 6 depicts one embodiment of an apparatus 600 for internet advertising that may be substantially similar to the apparatus 100 for internet advertising of FIG. 1. As described above, in one embodiment, the offer module 102 presents one or more promotions 112 to a first user in response to the first user entering the first purchasing context 110 for a first product. In response to an acceptance of the offer 114 by the first user, the publishing module 104, in one embodiment, creates at least one advertisement 116 corresponding to the first product. In one embodiment, the posting module 106 posts the at least one advertisement 116 created by the publishing module 104 to the one or more loop creation locations 122 selected by the first user. In one embodiment, the linking module 108, upon detecting user input corresponding to the advertisement 116, displays the second purchasing context 120.

In one embodiment, the apparatus 600 for internet advertising further comprises a data module 640 that, in response to the first user accepting the offer 114, receives a user identifier, an advertisement identifier, a product identifier, a loop creation location identifier, and a merchant identifier (“the identifiers”) and associates the identifiers with the advertisement 116 created by the publishing module 104.

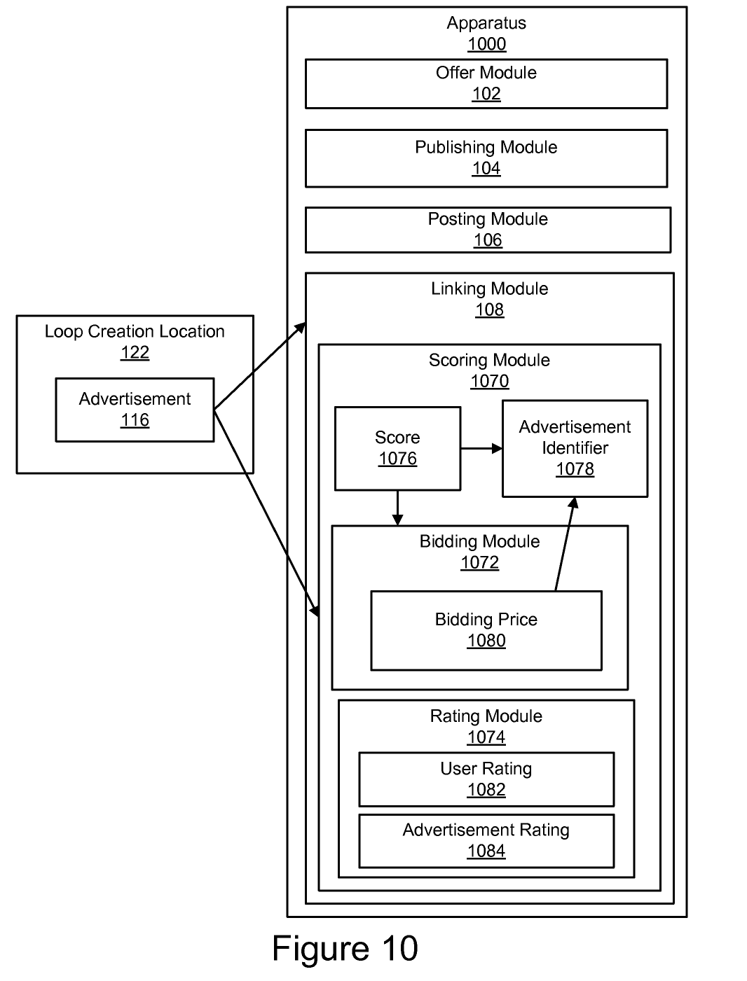

In one embodiment, the identifiers are stored by the data module 640 in a database associated with the data module 640. In one embodiment, the identifier are stored and associated with a user record associated with a user. A user record is a collection of data corresponding to actions of a user. In one embodiment, the database also contains advertisement records for each advertisement 116. An advertisement record is a collection of data corresponding to user input to an advertisement. In one embodiment, the advertisement record points to the user record that corresponds to the user that initiated the creation of the advertisement 116 associated with the advertisement record. In one embodiment, when another user clicks an advertisement 116, the linking module 108 receives an advertisement identifier for the advertisement 116. The linking module 108, in one embodiment, uses the advertisement identifier to locate the advertisement record associated with the advertisement identifier. In one embodiment, once the linking module 108 has located the advertisement record, the linking module 108 uses the user indicator from the advertisement record to locate the user record within the database. In one embodiment, the user record is the user record associated with the creation of the advertisement 116. In one embodiment, the data module 640 communicates with a scoring module 1070, further explained with reference to FIG. 10, and modifies a score associated with the advertisement 116 and stores the score associated with the advertisement in the advertisement record. In one embodiment, the scoring module increases the score associated with the advertisement 116 each time user input corresponding to the advertisement 116 is detected by the linking module 108.

In one embodiment, the data module 640 also receives, in response to detecting user input corresponding to the advertisement 116, a user identifier, an advertisement identifier, a product identifier, a loop creation location identifier, and a merchant identifier associated with the advertisement 116 (“second set of identifiers”). In one embodiment, the second set of identifiers is embedded in a URL of the link 118 within the advertisement 116. In one embodiment, when a user clicks the link 118, a user's web browser automatically delivers the URL and the embedded second set of identifiers to the data module 640.

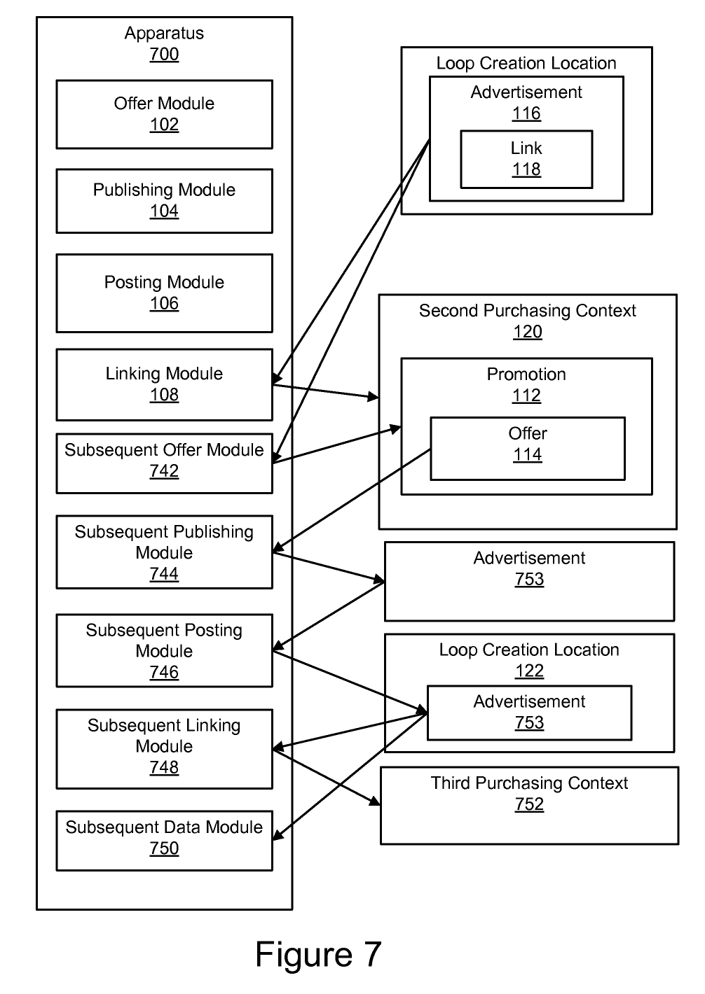

FIG. 7 depicts one embodiment of an apparatus 700 for internet advertising that may be substantially similar to the apparatus 100 for internet advertising of FIG. 1. The illustrated apparatus 700 includes an offer module 102, a publishing module 104, a posting module 106, a linking module 108, a subsequent offer module 742, a subsequent publishing module 744, a subsequent posting module 746, a subsequent linking module 748, and a subsequent data module 750. As described above, in one embodiment, the linking module 108 detects user input corresponding to the advertisement 116 and, in response to detecting user input corresponding to the advertisement 116, displays a second purchasing context 120.

In one embodiment, the subsequent offer module 742, in response to detecting user input corresponding to an advertisement 116, visually presents one or more promotions 112 to a subsequent user. In one embodiment, the one or more promotions 112 correspond to a product associated with the advertisement 116 and include an offer 114 that corresponds to the product.

In one embodiment, in response to the subsequent user accepting the offer 114, the subsequent publishing module 744 creates at least one advertisement 753 corresponding to the product. The advertisement 116 comprises a link 118 to a third purchasing context 752.

In one embodiment, the subsequent posting module 746 posts the at least one advertisement 753 created by the subsequent publishing module 744 to one or more loop creation locations 122 selected by the subsequent user. In one embodiment, the subsequent linking module 748 detects user input corresponding to the advertisement 753 and, in response to detecting user input corresponding to the advertisement 753, displays the third purchasing context 752. In one embodiment, the third purchasing context 752 is the same as the second purchasing context 120. In another embodiment, the third purchasing context 752, the second purchasing context 120, and the first purchasing context 110 are the same purchasing context.

In one embodiment, the apparatus 700 comprises a subsequent data module 750. In one embodiment, the subsequent data module 750, in response to an acceptance of the offer 114, receives a user identifier, an advertisement identifier, a product identifier, a loop creation location identifier, and a merchant identifier. The subsequent data module 750 also associates the user identifier, the advertisement identifier, the product identifier, the loop creation location identifier, and the merchant identifier with the advertisement 753. The subsequent data module 750 also receives, in response to detecting a user input corresponding to the advertisement 753, the user identifier, the advertisement identifier, the product identifier, the loop creation location identifier, and the merchant identifier associated with the advertisement 753.

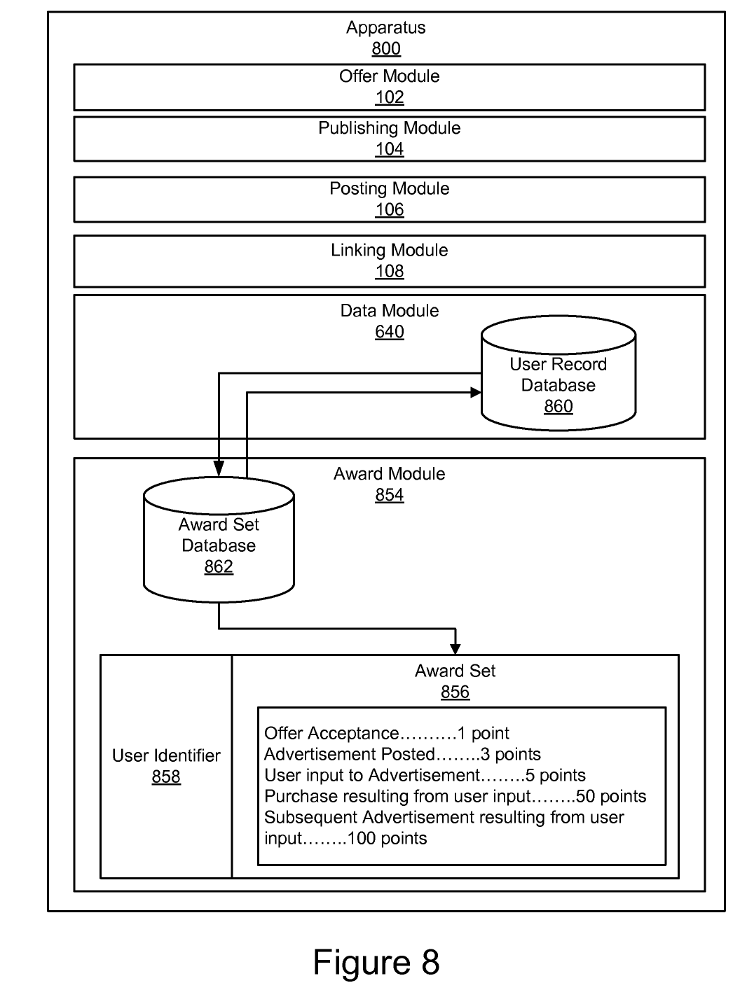

FIG. 8 depicts one embodiment of an apparatus 800 for internet advertising that may be substantially similar to the apparatus 100 of FIG. 1. The illustrated apparatus 800 includes an offer module 102, a publishing module 104, a posting module 106, a liking module, and an award module 854. As described above, in one embodiment, the offer module 102 presents one or more promotions 112 to a first user in response to the first user entering the first purchasing context 110 associated with a first product. In response to the first user accepting the offer 114, the publishing module 104 creates at least one advertisement 116 corresponding to the first product. In one embodiment, the posting module 106 posts the at least one advertisement 116 created by the publishing module 104 to the one or more loop creation locations 122 selected by the first user. The link 118 module, upon detecting user input corresponding to the advertisement 116, displays the second purchasing context 120.

In one embodiment, the award module 854 associates a user identifier 858 with an award set 856. In one embodiment, the award set 856 includes tasks that are associated with awards. In one embodiment, the tasks include offer acceptance, advertisement posting, user input to an advertisement, product purchase that results from a user input, and subsequent advertisement 116 resulting from user input to an advertisement 116. The award module 854 then records an award associated with the user identifier 858 in response to the first user completing a task within the award set 856. In one embodiment, in response to the linking module 108 detecting that an advertisement 118 has been clicked, the linking module 108 searches for the advertisement record associated with the advertisement 118 and then searches for the user record associated with the advertisement record. In one embodiment, the user records are stored in a user record database 860. In one example embodiment, the user record database 860 is a relational database. The linking module 108 then transfers the user record to the award module 854 and the award module 854 updates the first user's record with the appropriate award from the award set 856. In one embodiment, the award set 856 is stored in an award set database 862. In another embodiment, when another user makes a purchase of a product after following a link 118 in an advertisement 116, the award module 854 the user record associated with the advertisement 116 is updated with the appropriate award from the award module 854.

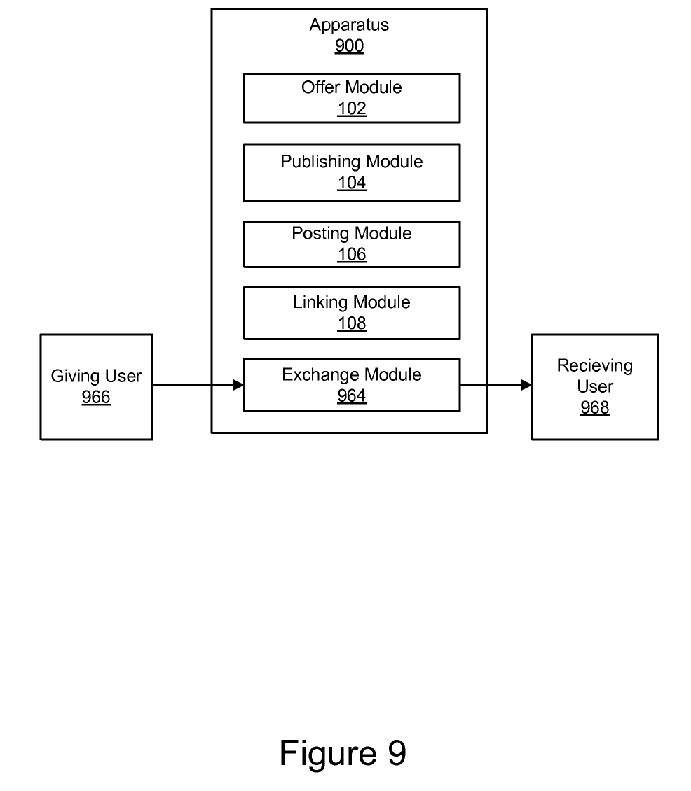

FIG. 9 depicts one embodiment of an apparatus 900 for internet advertising that may be substantially similar to the apparatus 100 of FIG. 1. The illustrated apparatus 900 includes an offer 114 module 102, a publishing module 104, a posting module 106, a liking module, and an exchange module 964. As described above, in one embodiment, the award module 854 records an award associated with the user identifier 858 in response the user associated with the user identifier 858 completing tasks within the award set 856.

In one embodiment, the exchange module 964 receives an award from a giving user 966 and deposits the award with a receiving user 968. In one example, a giving user 966 has a number of awards in the giving user's user record. When the exchange module 964 receives user input from the giving user 966 indicating that a certain reward is to be transferred to a receiving user 968, the exchange module 964 notifies the data module 640 and the data module 640 deducts the award from the giving user's user record and adds the award to the receiving user's user account.

FIG. 10 depicts one embodiment of an apparatus 1000 for internet advertising that may be substantially similar to the apparatus 100 of FIG. 1. The illustrated apparatus 1000 includes an offer module 102, a publishing module 104, a posting module 106, a linking module 108, and a scoring module 1070 contained within the linking module 108. In one embodiment, the scoring module 1070 comprises a bidding module 1072 and a rating module 1074. As described above, in one embodiment, the linking module 108 detects user input corresponding to one of the at least one advertisements 116, and, in response to detecting user input corresponding to the advertisement 116, displays the second purchasing context 120.

In one embodiment, linking module 108 includes a scoring module 1070 that assigns a score 1076 to an advertisement identifier 1078 associated with an advertisement 116 according to the number of detected user inputs corresponding to the advertisement 116. In one embodiment, the scoring module 1070 increases the score 1076 associated with an advertisement identifier 1078 for each detected user input to the advertisement 116. In another embodiment, the scoring module 1070 only increases the score 1076 associated with an advertisement identifier 1078 for each user input which corresponds to a unique originating IP address. In one embodiment, a high score 1076 corresponds to a high number of detected user inputs. In one embodiment, detected user inputs include a click on the advertisement 116 and a page view of a webpage of the loop creation location 122 on which the advertisement 116 if posted.

In another embodiment, the scoring module 1070 comprises a bidding module 1072 that receives the score assigned to an advertisement identifier 1078, associates a bidding price 1080 with the score 1076, and associates the bidding price 1080 with the advertisement identifier 1078. In one embodiment, the bidding price 1080 is a dollar amount associated with an instance of user input to an advertisement 116. In one embodiment, the scoring module 1070 associates a high bidding price 1080 with a high score 1076.

In another embodiment, the scoring module 1070 further comprises a rating module 1074 that, in response to detecting a user input corresponding to the advertisement 116, receives user input in the form of a user rating 1082 associated with the first user and an advertisement rating 1064 associated with the advertisement 116. In one embodiment, the scoring module 1070 visually presents a window which comprises a user selectable rating scale corresponding to a user rating 1082 and user selectable rating scale corresponding to an advertisement rating 1064. The scoring module 1070 receives the user input associated with the user rating 1082 and the advertisement rating 1084 and associates the user rating 1082 with a user identifier 858 and the advertising rating 1084 with an advertising identifier.

FIG. 11 depicts one embodiment of an apparatus 1100 for internet advertising that may be substantially similar to the apparatus 100 for internet advertising of FIG. 1. The illustrated apparatus 1100 includes an offer module 102, a publishing module 104, a posting module 106, and a linking module 108. As described above, in one embodiment, the publishing module 104 creates at least one advertisement 116 corresponding to the first product in response to an acceptance of the offer 114 by the first user.

In one embodiment, the publishing module 104 creates the at least one advertisement 116 corresponding to the first product automatically by combining product data retrieved from a product database 1194 according to a predetermined algorithm. In one embodiment, the advertisement 116 includes an advertisement offer 1186, a link 118, a description of the product 1190, and a product image 1192. In one embodiment, the algorithm is a pre-determined advertisement layout in which a location on the pre-determined advertisement layout is allotted for the advertisement offer 1186, the link 118, the product description 1190, and the product image 1192. In one embodiment, the publishing module 104 receives the advertisement offer 1186, the link 118, the product description 1190, and the product image 1192, and displays each in the respective location that is allotted for each. In one embodiment, the algorithm is an advertisement template. In one embodiment, the publishing module 104 includes a single advertisement template. In another embodiment, the publishing module 104 includes several different templates corresponding to different product types or categories.

In one embodiment, the product image 1192 conforms to one of the Internet Advertising Bureau's banner sizes. In one embodiment, the product image 1192 is one of a static GIF or JPEG image, a GIF-animated image, and a rich media image consisting of audio and/or video.

FIG. 12 depicts one embodiment of an apparatus 1200 for internet advertising that may be substantially similar to the apparatus 100 for internet advertising of FIG. 1. The illustrated apparatus 1200 includes an offer 114 module 102, a publishing module 104, a posting module 106, and a linking module 108. As described above, in one embodiment, the publishing module 104 creates at least one advertisement 116 corresponding to the first product in response to the first user accepting the offer 114.

In one embodiment, the publishing module 104 creates the advertisement 116 corresponding to the first product by retrieving a pre-designed advertisement 1296 from a product database 1194. In one embodiment, the publishing module 104 searches the product database 1194 for the product, locates the product, and retrieves a pre-designed advertisement 1296 associated with the product. In various embodiments, advertisements 116 within the product database 1194 may be associated with unique product identifiers, with categories of product identifiers, with groups of product identifiers, and/or some other association.

In one embodiment, if no advertisement 116 is associated with the first product, the publishing module 104 searches the database for products that are similar to the first product. In another embodiment, if no advertisement 116 exists for the first product, the publishing module 104 searches the database for products that were also purchased by users that purchased the first product or for products that might be useful in conjunction with the first product.

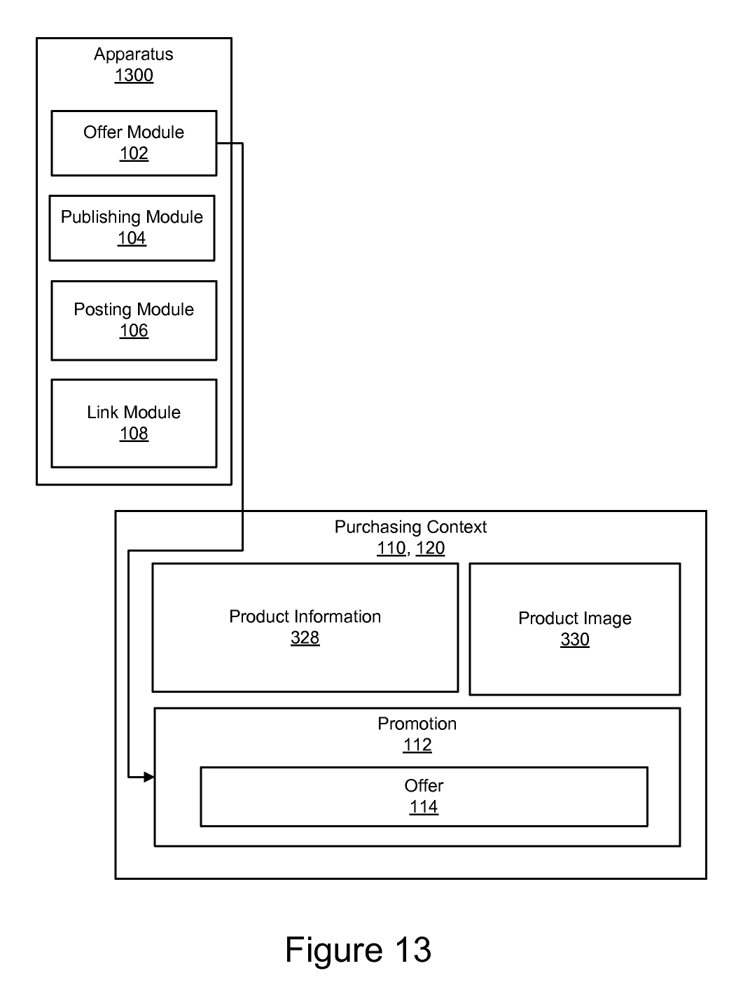

FIG. 13 depicts one embodiment of an apparatus 1300 for internet advertising that may be substantially similar to the apparatus 100 for internet advertising of FIG. 1. The illustrated apparatus 1300 includes an offer module 102, a publishing module 104, a posting module 106, and a link 118 module. As described above, in one embodiment, the offer 114 module 102 visually presents one or more promotions 112 to a first user in response to the first user entering a first purchasing context 110 for a first product.

In one embodiment, the offer module 102 visually presents the one or more promotions 112 to a first user by integrating the one or more promotions 112 into the purchasing context for a first product.

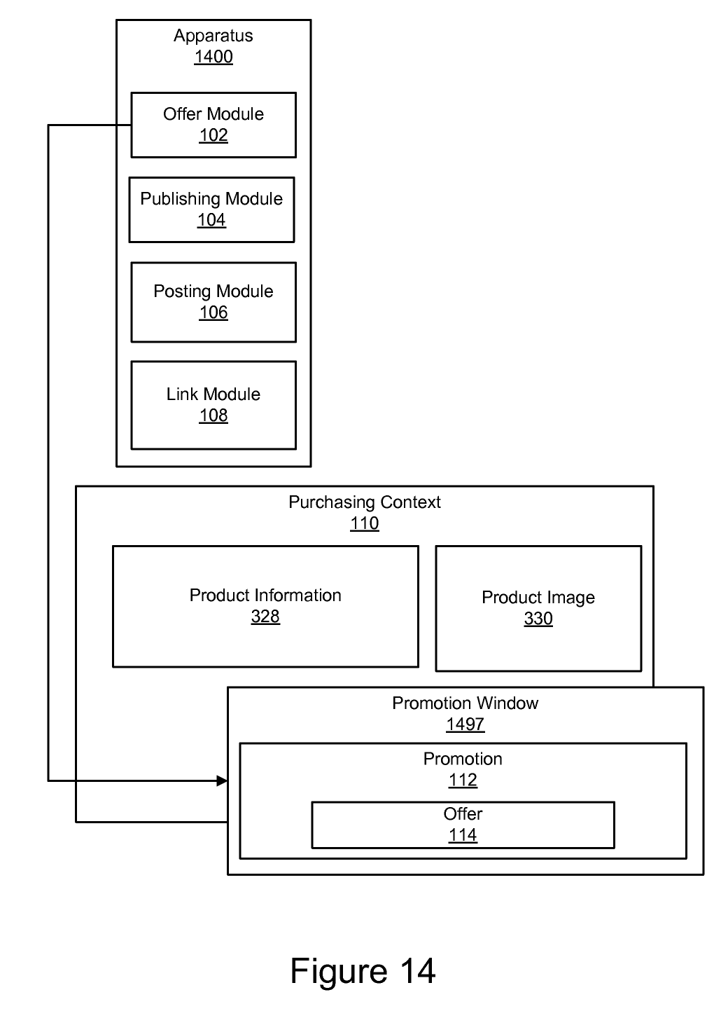

FIG. 14 depicts one embodiment of an apparatus 1400 for internet advertising that may be substantially similar to the apparatus 100 for internet advertising of FIG. 1. The illustrated apparatus 1400 includes an offer 114 module 102, a publishing module 104, a posting module 106, and a link 118 module. As described above, in one embodiment, the offer 114 module 102 visually presents one or more promotions 112 to a first user in response to the first user entering a first purchasing context 110 for a first product.

In one embodiment, the offer module 102 visually presents the one or more promotions 112 to a first user by presenting a window comprising the one or more promotions 112.

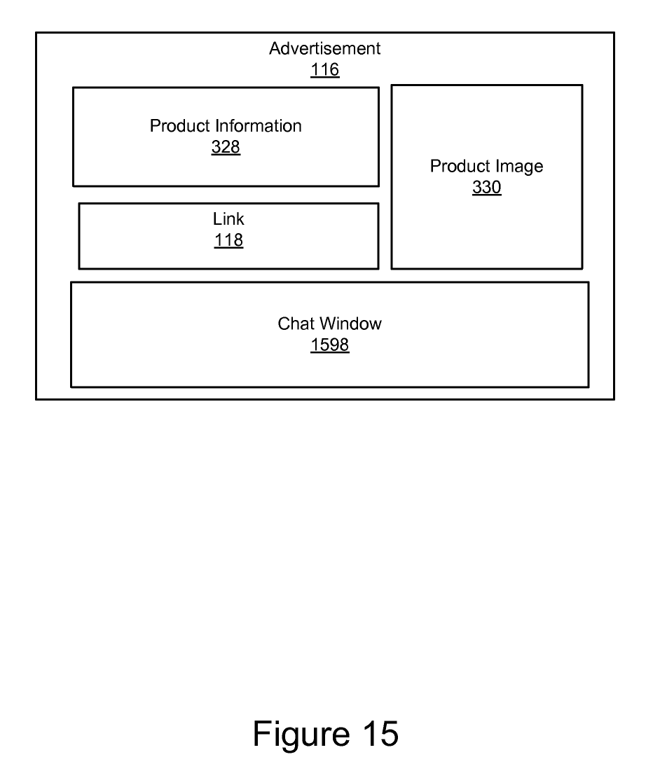

FIG. 15 depicts one embodiment of an advertisement 116 that may be substantially similar to the advertisement 116 of FIG. 1. The illustrated advertisement 116 includes product information 328, a link 118, and a chat window 1598. As described above, in one embodiment, the advertisement 116 includes a link 118 to a second purchasing context 120 and is posted to one or more loop creation locations 122 by the posting module 106.

In one embodiment, the advertisement 116 further includes a chat window that receives user input from a subsequent user and displays the user input to the first user.

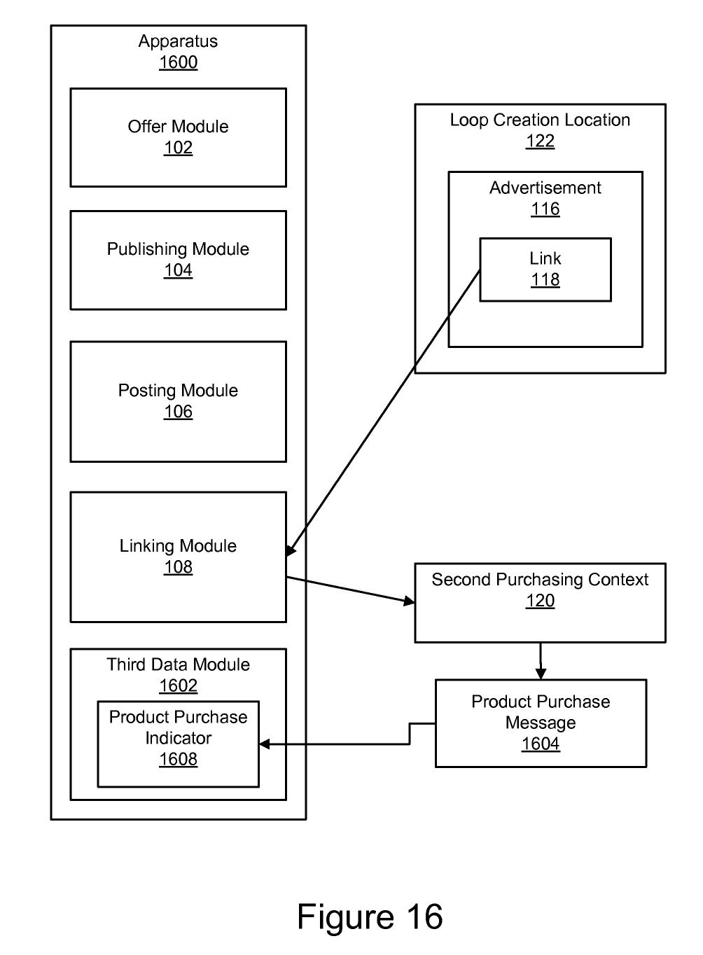

FIG. 16 depicts one embodiment of an apparatus 1600 for internet advertising that may be substantially similar to the apparatus 100 for internet advertising of FIG. 1. The illustrated apparatus 1600 includes an offer module 102, a publishing module 104, a posting module 106, a linking module 108, and a third data module 1602. As described above, in one embodiment, the linking module 108 detects user input corresponding to one of the at least one advertisements 116 and, in response to detecting user input corresponding to the advertisement 116, displays the second purchasing context 120.

In one embodiment, the third data module 1602 detects user input corresponding to one of the at least one advertisements 116 and receives a product purchase indicator associated with the purchase of the product associated with the advertisement 116. The third data module 1602 records a product purchase indicator associated with the advertisement 116 upon receiving the product purchase indicator. In one embodiment, the third data module 1602 receives a product purchase message 1604 from the web server of the second purchasing context 120 that has been sent over a secure communications protocol such as HTTPS. In one embodiment, the product purchase message 1604 includes the product purchase indicator and the advertisement 116 indicator. In one embodiment, the third data module 1602 sends a product purchase message 1604 to the award module 854 and the award module 854 updates the user record with an award corresponding to a product purchase.

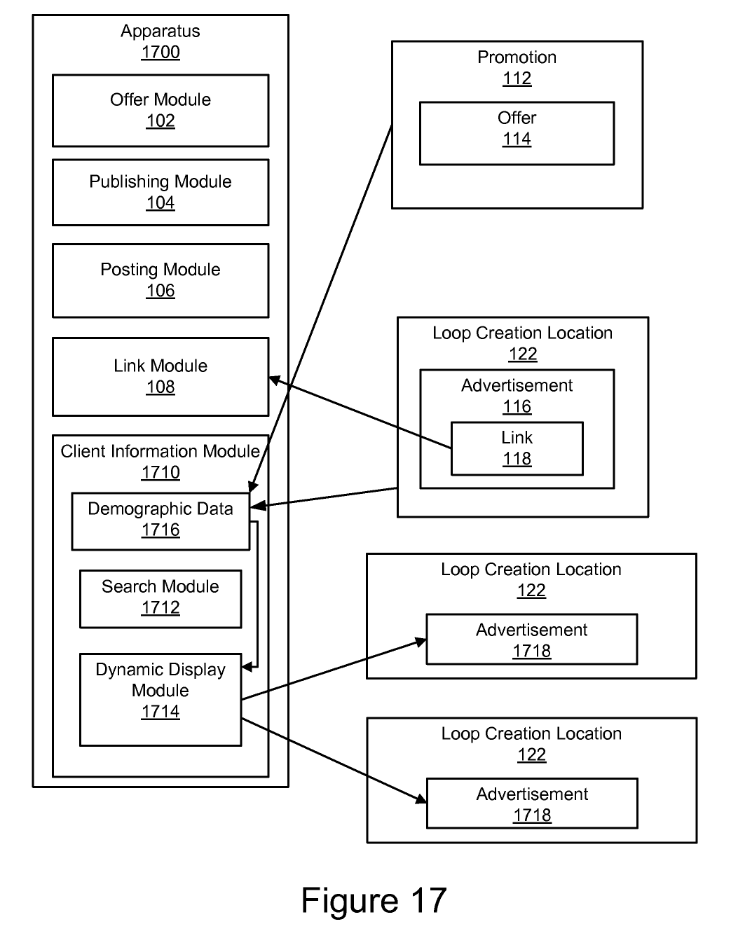

FIG. 17 depicts one embodiment of an apparatus 1700 for internet advertising that may be substantially similar to the apparatus 100 for internet advertising of FIG. 1. The illustrated apparatus 1700 includes an offer module 102, a publishing module 104, a posting module 106, a linking module 108, and a client information module 1710. The illustrated client information module 1710 includes a search module 1712 and a dynamic display module 1714. As described above, in one embodiment, the linking module 108 detects user input corresponding to one of the at least one advertisements 116.

In one embodiment, the client information module 1710 detects user input corresponding to the advertisement 116 and detects user input corresponding to the offer 114. In response to detecting user input corresponding to the advertisement 116 or the offer 114, the client information module 1710 visually presents a demographic data menu to a user. The client information module 1710 receives and records demographic data 1716 from the user input to the demographic data menu. In one embodiment, the client information module 1710 associates the demographic data 1716 with a user identifier, an advertisement identifier, and a product identifier.

In another embodiment, the client information module 1710 further comprises a search module 1712 that receives demographic data user input from a user, searches for products associated with the demographic data user input, and visually displays products that are associated with the demographic data user input.

In another embodiment, the client information module 1710 further comprises a dynamic display module 1714. The dynamic display module 1714 receives demographic data 1714 associated with a particular product from the client information module 1710. The dynamic display module 1714 locates loop creation locations 122 that correspond to users with similar demographic data 1716. The dynamic display module 1714 then posts advertisements 116 corresponding to the product on the loop creation locations 122.

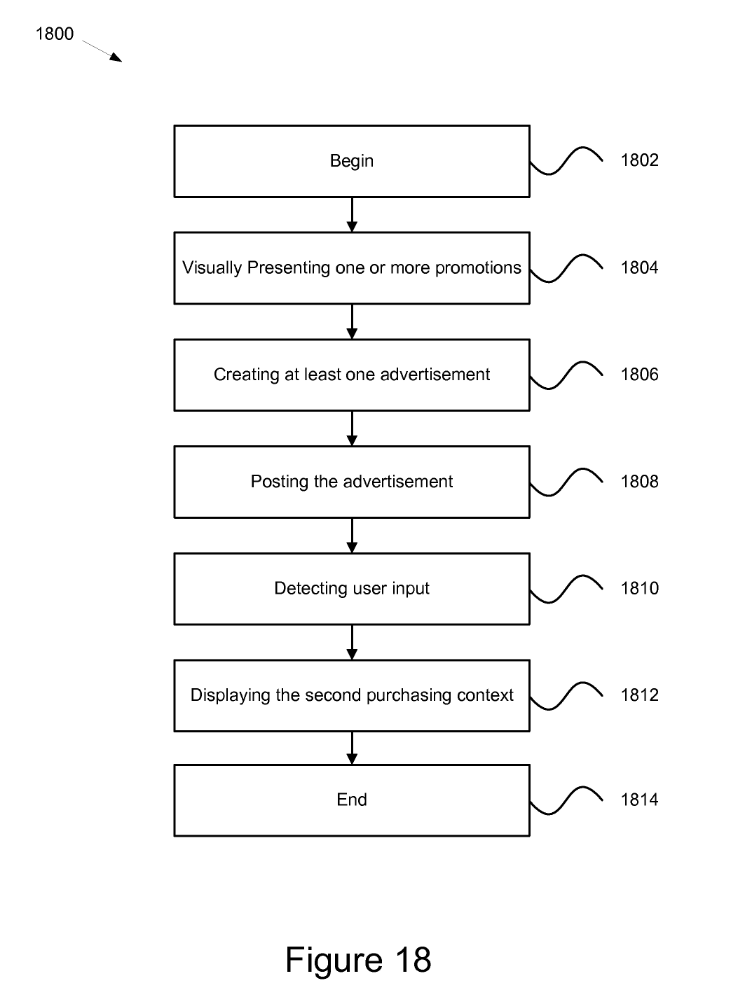

FIG. 18 depicts one embodiment of a method 1800 for internet advertising that may be implemented by the apparatus 100 for internet advertising of FIG. 1. In the illustrated method for internet advertising, the method begins 1802 and one or more promotions 112 are visually presented 1804 to a first user in response to the first user entering a first purchasing context 110 for a first product. In one embodiment, the one or more promotions 112 include an offer 114 that corresponds to the first product. In response to an acceptance of the offer 114 by the first user, in one embodiment, at least one advertisement 116 corresponding to the first product is created 1806. In one embodiment, the at least one advertisement 116 includes a link 118 to a second purchasing context 120.

In one embodiment, the at least one advertisement 116 is posted 1808 to one or more loop creation locations 122 selected by the first user. In one embodiment, user input corresponding to one of the at least one advertisements is detected 1810. In response to detecting user input corresponding to the advertisement 116, the second purchasing context 120, in one embodiment, is displayed 1812. The method then ends 1814.

In one embodiment, visually presenting one or more promotions 112 includes searching a product database and locating an offer 114 that corresponds to the first product by locating an offer 114 that is associated with a category of the first product. In another embodiment, the first purchasing context 110 and the second purchasing context 120 are the same purchasing context.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for internet advertising, the apparatus comprising:
an offer module that visually presents one or more promotions to a first user in response to the first user entering a first purchasing context associated with a first product, wherein the one or more promotions comprise an offer that corresponds to the first product;
a publishing module that, in response to an acceptance of the offer by the first user, creates at least one advertisement corresponding to the first product, wherein the at least one advertisement comprises a link to a second purchasing context;
a posting module that posts the at least one advertisement created by the publishing module to one or more loop creation locations selected by the first user; and
a linking module that detects user input corresponding to one of the at least one advertisements and, in response to detecting the user input corresponding to the one of the at least one advertisements, displays the second purchasing context.

2. The apparatus of claim 1, wherein the first purchasing context and the second purchasing context are the same purchasing context.

3. The apparatus of claim 1, wherein the one or more promotions comprise a user selectable list of one or more loop creation locations, wherein a loop creation location comprises at least one of a portion of a webpage and a webpage.

4. The apparatus of claim 1, wherein the publishing module further comprises a user information module that, in response to an acceptance of the offer by the first user, receives user input corresponding to a user selectable list of one or more loop creation locations, stores the user input, and associates the user input with the first user, wherein a loop creation location comprises at least one of a portion of a webpage and a webpage.

5. The apparatus of claim 1, wherein the offer module searches a product database and locates an offer that corresponds to the first product by locating an offer that is associated with a category of the first product.

6. The apparatus of claim 1, further comprising a data module that, in response to an acceptance of the offer by the first user, receives a user identifier, an advertisement identifier, a product identifier, a loop creation location identifier, and a merchant identifier and associates the user identifier, the advertisement identifier, the product identifier, the loop creation location identifier, and the merchant identifier with the advertisement created by the publishing module, wherein the data module also receives, in response to detecting a user input corresponding to the advertisement, the user identifier, the advertisement identifier, the product identifier, the loop creation location identifier, and the merchant identifier associated with the advertisement.

7. The apparatus of claim 1, further comprising,
a subsequent offer module that, in response to detecting user input corresponding to an advertisement, visually presents one or more promotions to a subsequent user, wherein the one or more promotions correspond to a product associated with the advertisement and comprise an offer that corresponds to the product;
a subsequent publishing module that, in response to an acceptance of the offer by the subsequent user, creates at least one advertisement corresponding to the product, wherein the at least one advertisement comprises a link to a third purchasing context;
a subsequent posting module that posts the at least one advertisement created by the subsequent publishing module to one or more loop creation locations selected by the subsequent user; and
a subsequent linking module that detects user input corresponding to the advertisement and, in response to detecting the user input corresponding to the advertisement, displays the third purchasing context.

8. The apparatus of claim 7, further comprising a second data module that, in response to an acceptance of the subsequent offer, receives a user identifier, an advertisement identifier, a product identifier, a loop creation location identifier, and a merchant identifier, and associates the user identifier, the advertisement identifier, the product identifier, the loop creation location identifier, and the merchant identifier with the subsequent advertisement, wherein the second data module also receives, in response to detecting a user input corresponding to the subsequent advertisement, the user identifier, the advertisement identifier, the product identifier, the loop creation location identifier, and the merchant identifier associated with the subsequent advertisement.

9. The apparatus of claim 1, further comprising an award module that associates a user identifier with an award set, wherein the award set comprises tasks that are associated with awards, wherein the award module records an award associated with the user identifier in response to completion of a task within the award set.

10. The apparatus of claim 9, further comprising an exchange module that receives an award from a giving user and deposits the award with a receiving user.

11. The apparatus of claim 1, wherein the linking module further comprises a scoring module that assigns a score to an advertisement identifier associated with an advertisement according to a number of detected user inputs corresponding to the advertisement.

12. The apparatus of claim 11, wherein the scoring module further comprises a bidding module that receives a score assigned to an advertisement identifier, associates a bidding price with the score, and associates the bidding price with the advertisement identifier.

13. The apparatus of claim 11, wherein the scoring module further comprises a rating module that, in response to detecting a user input corresponding to the advertisement, receives user input in the form of a user rating associated with the first user and an advertisement rating associated with the advertisement.

14. The apparatus of claim 1, wherein the publishing module creates the at least one advertisement corresponding to the first product automatically by combining product data retrieved from a product database according to a predetermined algorithm.

15. The apparatus of claim 1, wherein the publishing module creates the at least one advertisement corresponding to the first product by retrieving a pre-designed advertisement from a product database.

16. The apparatus of claim 1, wherein the loop creation location comprises at least one of a personal information page on a social networking website, a text based post displayed on one or more webpages, a text based post on one or more cell phones, a personal webpage, and an internet search page.

17. The apparatus of claim 1, wherein the offer module visually presents the one or more promotions to the first user by integrating the one or more promotions into the purchasing context for the first product.

18. The apparatus of claim 1, wherein the offer module visually presents the one or more promotions to the first user by presenting a window comprising the one or more promotions.

19. The apparatus of claim 1, wherein the first purchasing context comprises a webpage that makes a product offer to the first user, the product offer corresponding to the first product.

20. The apparatus of claim 1, wherein the first purchasing context comprises at least one of an e-commerce webpage, an online store website, a lead generation website, a subscription website, a services subscription website, a movie review website, a book review website, a political campaign website, and a charity donation website.

21. The apparatus of claim 1, wherein the first product comprises at least one of a product for sale online, a service for sale online, a subscription, a promotion, a news piece, a solicitation for a donation, a solicitation to fill out a form, a solicitation to enter personal information, and a solicitation to give feedback concerning one or more of a movie, a book, music, software, and a product.

22. The apparatus of claim 1, wherein the advertisement further comprises a chat window that receives user input from a subsequent user and displays the user input to the first user.

23. The apparatus of claim 1, further comprising a third data module that detects user input corresponding to one of the at least one advertisements and receives a product purchase indicator associated with the purchase of the first product, wherein the third data module records a product purchase indicator associated with the advertisement.

24. The apparatus of claim 1, further comprising a client information module that, in response to detecting user input corresponding to the advertisement, visually presents a demographic data menu to a second user and associates the demographic data from the user input with a user identifier, an advertisement identifier, and a product identifier.

25. The apparatus of claim 24, wherein the client information module further comprises a search module that allows a user to search for products associated with demographic data recorded by the client information module.

26. The apparatus of claim 24, wherein the client information module further comprises a dynamic display module that receives demographic data associated with a product from the client information module, locates other loop creation locations that correspond to the demographic data, and then posts at least one advertisement corresponding to the product to the located loop creation locations.

27. The apparatus of claim 1, wherein the first product comprises an audio file and wherein the advertisement corresponding to the first product further comprises a link to a portion of the audio file.

28. A method for internet advertising, the method comprising:
visually presenting one or more promotions to a first user in response to the first user entering a first purchasing context for a first product, wherein the one or more promotions comprise an offer that corresponds to the first product;
creating, in response to an acceptance of the offer by the first user, at least one advertisement corresponding to the first product, wherein the at least one advertisement comprises a link to a second purchasing context;
posting the at least one advertisement created by the publishing module to one or more loop creation locations selected by the first user;
detecting user input corresponding to one of the at least one advertisements; and
displaying, in response to detecting the user input corresponding to the one of the at least one advertisements, the second purchasing context.

29. The method of claim 28, wherein visually presenting one or more promotions comprising an offer that corresponds to the first product comprises searching a product database and locating an offer that corresponds to the first product by locating an offer that is associated with a category of the first product.

30. A computer program product comprising a computer readable medium having computer usable program code executable to perform operations for internet advertising, the operations of the computer program product comprising:
visually presenting one or more promotions to a first user in response to the first user entering a first purchasing context for a first product, wherein the one or more promotions comprise an offer that corresponds to the first product;
creating, in response to an acceptance of the offer by the first user, at least one advertisement corresponding to the first product, wherein the at least one advertisement comprises a link to a second purchasing context;
posting the at least one advertisement created by the publishing module to one or more loop creation locations selected by the first user;
detecting user input corresponding to one of the at least one advertisements; and
displaying, in response to detecting user input corresponding to the one of the at least one advertisements, the second purchasing context.

31. The computer program product of claim 30, wherein the first purchasing context and the second purchasing context are the same purchasing context.
